(19) United States
(12) Patent Application Publication
(10) Pub. No.: US 2018/0330288 A1
(43) Pub. Date: Nov. 15, 2018

(54) METHOD OF DATA AGGREGATION FOR CACHE OPTIMIZATION AND EFFICIENT PROCESSING

(71) Applicant: Alteryx, Inc., Irvine, CA (US)

(72) Inventors: Edward P. Harding, JR., Boulder, CO (US); Adam D. Riley, Orwell (GB); Christopher H. Kingsley, Longmont, CO (US); Scott Wiesner, Boulder, CO (US)

(21) Appl. No.: 15/595,880

(22) Filed: May 15, 2017

(51) Int. Cl. G06Q 10/06; G06F 12/0875; G06F 9/30

(52) U.S. Cl. CPC G06Q 10/063; G06F 9/3009; G06F 9/3005; G06F 12/0875

(57) ABSTRACT

A data stream comprising a plurality of data records is retrieved. Portions of the data stream are aggregated to form a plurality of record packets of a predetermined size capacity. Each of the plurality of record packets comprises a number of data records from the plurality of data records. Further, the predetermined size capacity is an order of magnitude of a memory size of a cache memory associated with the data processing apparatus. Each of the plurality of record packets is transferred to respective ones of a plurality of threads associated with one or more processing operations. Each of the plurality of threads run independently on a respective processor from among a plurality of processors associated with the data processing apparatus.

### BACKGROUND

This specification generally relates to methods and systems for aggregating data for optimized caching and efficient processing in various parallel processing computer systems (e.g., multi-core processors). The described data aggregation techniques are usable in a data processing environment, such as a data analytics platform.

The growth of data analytic platforms, such as Big Data Analytics, has expanded data processing into a tool used to leverage the processing of large volumes of data into opportunities to extract information that can be monetized or contain other business value. Thus, efficient data processing techniques that can be employed in accessing, processing, and analyzing large sets of data from differing data sources may be necessary. For example, a small business may utilize a third-party data analytics environment employing dedicated computing and human resources that are needed to gather, process, and analyze vast amounts of data from various sources, such as external data providers, internal data sources (e.g., files on local computers), Big Data stores, and cloud-based data (e.g., social media application). To process such large data sets, as used in data analytics, in a manner that extracts useful quantitative (e.g., statistical, prediction) and qualitative information that can be further applied in business areas, for example, it may require complex software tools implemented on powerful computer devices to support each stage of data analytics (e.g., access, preparation and processing).

### SUMMARY

The above and other issues are addressed by a method, data processing apparatus, and non-transitory computer readable memory that use data aggregation for cache optimization and efficient processing. An embodiment of the method is performed by a data processing apparatus and comprises retrieving a data stream comprising a plurality of data records, aggregating the plurality of data records of the data stream to form a plurality of record packets of a predetermined size capacity, the predetermined size capacity determined responsive to a memory size of a cache memory associated with the data processing apparatus, and transferring respective ones of the plurality of record packets to respective ones of a plurality of threads associated with one or more processing operations of the data processing apparatus.

An embodiment of the data processing apparatus comprises a non-transitory memory storing executable computer program code and a plurality of computer processors having a cache memory and communicatively coupled to the memory, the computer processors executing the computer program code to perform operations. The operations comprise retrieving a data stream comprising a plurality of data records, aggregating the plurality of data records of the data stream to form a plurality of record packets of a predetermined size capacity, the predetermined size capacity determined responsive to a memory size of the cache memory, and transferring respective ones of the plurality of record packets to respective ones of a plurality of threads associated with one or more processing operations of the plurality of processors.

An embodiment of the non-transitory computer-readable memory stores computer program code executable to perform operations using a plurality of computer processors having a cache memory. The operations comprise retrieving a data stream comprising a plurality of data records, aggregating the plurality of data records of the data stream to form a plurality of record packets of a predetermined size capacity, the predetermined size capacity determined responsive to a memory size of the cache memory, and transferring respective ones of the plurality of record packets to respective ones of a plurality of threads associated with one or more processing operations of the plurality of processors.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is a diagram of an example environment for implementing data aggregation for optimized caching and efficient processing.

FIGS. 2A-2B are diagrams of an example of a data analytics workflow employing data aggregation for optimized caching and efficient processing.

FIG. 3 is a flow chart of an example process of implementing data aggregation for optimized caching and efficient processing.

FIG. 4 is a diagram of an example of a computing device that may be used to implement the systems and methods described herein.

FIG. 5 is a diagram of an example of a data processing apparatus including a software architecture that may be used to implement the systems and methods described herein.

Like reference numbers and designations in the various drawings indicate like elements.

### DETAILED DESCRIPTION

In businesses, corporations and other organizations, there may be an interest in obtaining data that is pertinent to business-related functions (e.g., customer engagement, process performance, and strategic decision-making). Advance data analytics techniques (e.g., text analytics, machine learning, predictive analysis, data mining and statics) can then be used by businesses, for example, to further analyze the collected data. Also, with the growth of electronic commerce (e-commerce) and integration of personal computer devices and communication networks, such as the Internet, into the exchange of goods, services, and information between businesses and customers, large volumes of business-related data are transferred and stored in electronic form. Vast amounts of information that may be of importance to a business (e.g., financial transactions, customer profiles, etc.) can be accessed and retrieved from multiple data sources using network-based communication. Due to the disparate data sources and the large amounts of electronic data that may contain information of potential relevance to a data analyzer, performing data analytics operations can involve processing very large, diverse data sets that include different data types such as structured/unstructured data, streaming or batch data, and data of differing sizes that vary from terabytes to zettabytes.

Furthermore, data analytics may require complicated and computationally-heavy processing of different data types to recognize patterns, identify correlations and other useful information. Some data analytics systems leverage the functionality provided by large, complex and expensive computer devices, such as data warehouses and high performance computers (HPCs), such as mainframes, to handle larger storage capacities and processing demands associated with big data. In some cases, the amount of computing power needed to collect and analyze such extensive amounts of data can present challenges in an environment having resources with limited capabilities, such as the traditional information technology (IT) assets available on the network of a small business (e.g., desktop computers, servers). For instance, a laptop computer may not include the hardware needed to support the demands associated with processing hundreds of terabytes of data. Consequently, Big Data environments can employ higher-end hardware or high performance computing (HPC) resources generally running on large and costly supercomputers with thousands of servers to support the processing of large data sets across clustered computer systems. Although speed and processing power of computers, such as desktop computers, have increased, nonetheless data amounts and sizes in data analytics increased as well, making the use of traditional computers with limited computational capabilities (as compared to HPCs) less than optimal for some current data analytics technologies. As an example, a compute-intensive data analytics operation that processes one data record at a time in a single thread of execution may result in undesirably long computation times executing on a desktop computer, for instance, and further may not take advantage of the parallel processing capabilities of multi-core central processing units (CPUs) available in some existing computer architectures. However, incorporating a software architecture, usable in current computer hardware, which provides efficient scheduling and processor and/or memory optimization, for example using a multi-threaded design, can provide effective data analytics processing in lower complexity, or traditional IT, computer assets.

Accordingly, the present specification describes techniques for processing data that includes effectively aggregating data in a manner that can optimize the performance of computing resources by utilizing parallel processing, supporting better utilization of storage, and providing improved memory efficiency. One example method includes retrieving a data stream comprising a plurality of data records. Portions of the data stream are aggregated to form a plurality of record packets of a predetermined size capacity. Each of the plurality of record packets comprises a number of data records from the plurality of data records. Further, the predetermined size capacity is determined responsive a memory size of a cache memory associated with the data processing apparatus. In one embodiment, the predetermined size capacity is an order of magnitude of the memory cache size. Each of the plurality of record packets is transferred to a plurality of threads associated with one or more processing operations. Each of the plurality of threads run independently on a respective processor from among a plurality of processors associated with the data processing apparatus.

Implementations using techniques according to the present disclosure have several potential advantages. First, the present techniques may allow for an improvement in data locality, or otherwise keeping data in a memory that is readily accessible to the computing element (e.g., CPU, RAM, etc.) that will be used during processing. For example, the present techniques may enable a processing operation, included in a data analytics workflow for example, to simultaneously process an aggregated group of data records, rather than a single data record. Therefore, the likelihood that data associated with the processed data records will be available in a cache memory of a computer device that potentially needs to be further accessed by subsequent operations, for example, is increased. As a result of the improved data locality, the techniques can also realize reductions in latency that may be experienced in accessing data. Consequently, the disclosed techniques may optimize operation of computer resources, such as cache memory, CPUs, and the like, that are utilized to process data in some existing data analytics processing techniques, for instance linear ordering, that may otherwise scale poorly on computers devices implementing parallel processing technologies (e.g., multi-core CPUs, multi-threading, etc.).

Additionally, the techniques can be used to aggregate data in such a way that the size of a record packet, which is an aggregated group of multiple data records, enables a better optimized caching behavior. As an example, the described techniques can be employed to aggregate data records into a record packet of a particular size in relation to a cache memory. Processing record packets that are not too large, for instance larger than a storage capacity of the cache, may prevent a worst-case cache behavior scenario, such as a processing operation frequently attempting to access data that has recently been flushed from the cache. Moreover, the techniques can be used to increase data processing efficiency in parallel-processing computing environments, such as independent threads running on multiple cores on the same CPU. That is, the techniques can function to aggregate data records into record packets of a particular size so as to effectuate the distribution of data processing across a large number of CPU cores, and thus optimize utilization in computers utilizing multi-core processors. By using record packets sized to employ as many of the available processor cores during data processing as desirable, the techniques may help to prevent the sub-optimal case of aggregating data in a way that uses fewer cores, or only a single processor core. Also, the present techniques can be used to effectively aggregate data in order to reduce the overhead associated with passing data between threads in a multi-threading processing environment.

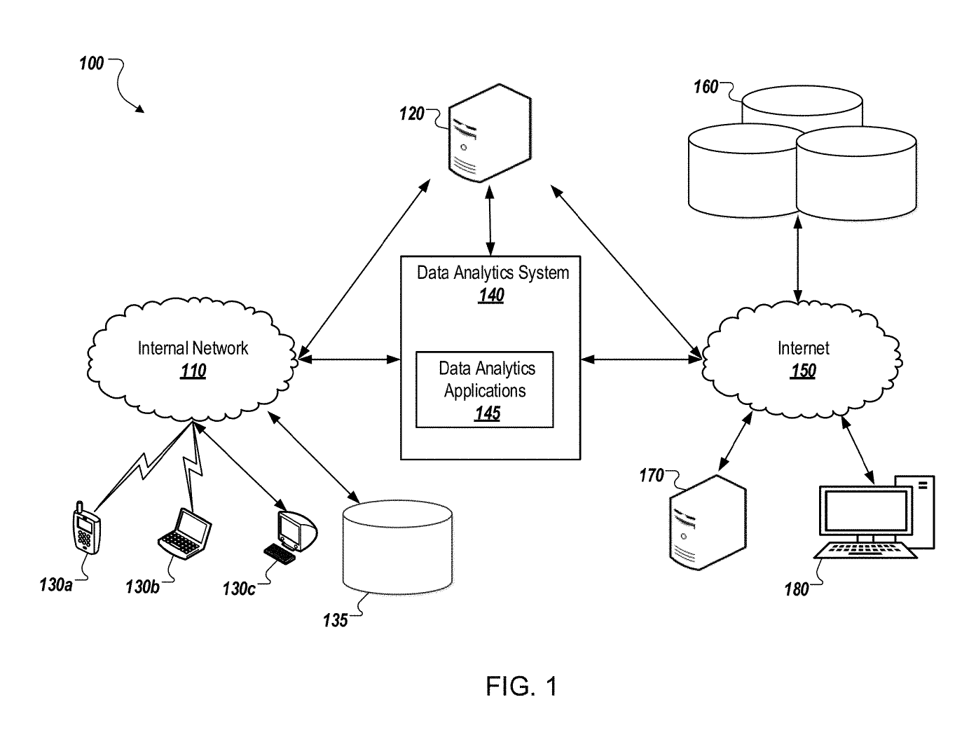

FIG. 1 is a diagram of an example environment 100 for implementing data aggregation for optimized caching and efficient processing in a data processing environment, such as a data analytics platform. As shown, the environment 100 includes an internal network 110, including a data analytics system 140, that is further connected to the Internet 150. The Internet 150 is a public network connecting multiple disparate resources (e.g., servers, networks, etc.). In some cases, Internet 150 may be any public or private network external to the internal network 110 or operated by a different entity than internal network 110. Data may be transferred over the Internet 150 between computers and networks connected thereto using various networking technologies, such as, for example, ETHERNET, Synchronous Optical Networking (SONET), Asynchronous Transfer Mode (ATM), Code Division Multiple Access (CDMA), Long Term Evolution (LTE), Internet Protocol (IP), Hypertext Transfer Protocol (HTTP), HTTP Secure (HTTPS), Domain Name System (DNS) protocol, Transmission Control Protocol (TCP), Universal Datagram Protocol (UDP), or other technologies.

As an example, the internal network 110 is a local area network (LAN) for connecting a plurality of client devices 130 with differing capabilities, such as handheld computing devices, illustrated as smart phone 130a and laptop computer 130b. A client device 130 also illustrated as connected to the internal network 110 is desktop computer 130c. The internal network 110 may be a wired or wireless network utilizing one or more network technologies, including, but not limited to, ETHERNET, WI-FI, CDMA, LTE, IP, HTTP, HTTPS, DNS, TCP, UDP, or other technologies. As a result, the Internet 150 can provide access to vast amounts of network accessible content to the client devices 130 communicatively connected to the network, for example by using networking technologies (e.g., Wi-Fi) and appropriate protocols (e.g., TCP/IP). The internal network 110 can support access to a local storage system, shown as database 135. As an example, database 135 can be employed to store and maintain internal data, or data otherwise obtained from sources local to the internal network 110 resources (e.g., files created and transmitted using client devices 130).

As shown in FIG. 1, Internet 150 can communicatively connect various data sources that are externally located from the internal network 110, illustrated as databases 160, server 170, and web server 180. Each of the data sources connected to Internet 150 can be used to access and retrieve electronic data, such as data records, for analytical processing of the information contained therein by a data processing platform, such as data analytics applications. Databases 160 can include a plurality of larger capacity storage devices used to gather, store, and maintain large volumes of data, or records, that can subsequently be accessed to compile data serving as input into data analytics applications or other existing data processing applications. As an example, databases 160 can be used in a Big Data storage system that is managed by a third-party data source. In some instances, external storage systems, such as Big Data storage systems can utilize commodity servers, illustrated as server 170, with direct-attached storage (DAS) for processing capabilities.

Additionally, web server 180 can host content that is made available to users, such as a user of client device 130, via the Internet 150. A web server 180 can host a static website, which includes individual web pages having static content. The web server 180 can also contain client-side scripts for a dynamic website that relies on server-side processing, for example server-side scripts such as PHP, Java Server Pages (JSP), or ASP.NET. The HTTP request may include a Uniform Resource Locator (URL) identifying the requested content. The web server 180 may be associated with a domain name, such as “example.com” thereby allowing it to be accessed using an address such as “www.example.com.” In some cases, web server 180 can act as an external data source by providing various forms of data that may be of interest to a business, for example data related to computer-based interactions (e.g., click tracking data) and content accessible on websites and social media applications. As an example, a client device 130 can request content available on the Internet 150, such as a website hosted by web server 180. Thereafter, clicks on hypertext links to other sites, content, or advertisements, made by the user while viewing the website hosted by web server 180 can be monitored, or otherwise tracked, and sourced from the cloud to server as input into a data analytics platform for subsequent processing. Other examples of external data sources that can be accessible by a data analytics platform via the Internet 150, for instance, can include but are not limited to: external data providers, data warehouses, third-party data providers, Internet Service Providers, cloud-based data providers, Software as a service (SaaS) platforms, and the like.

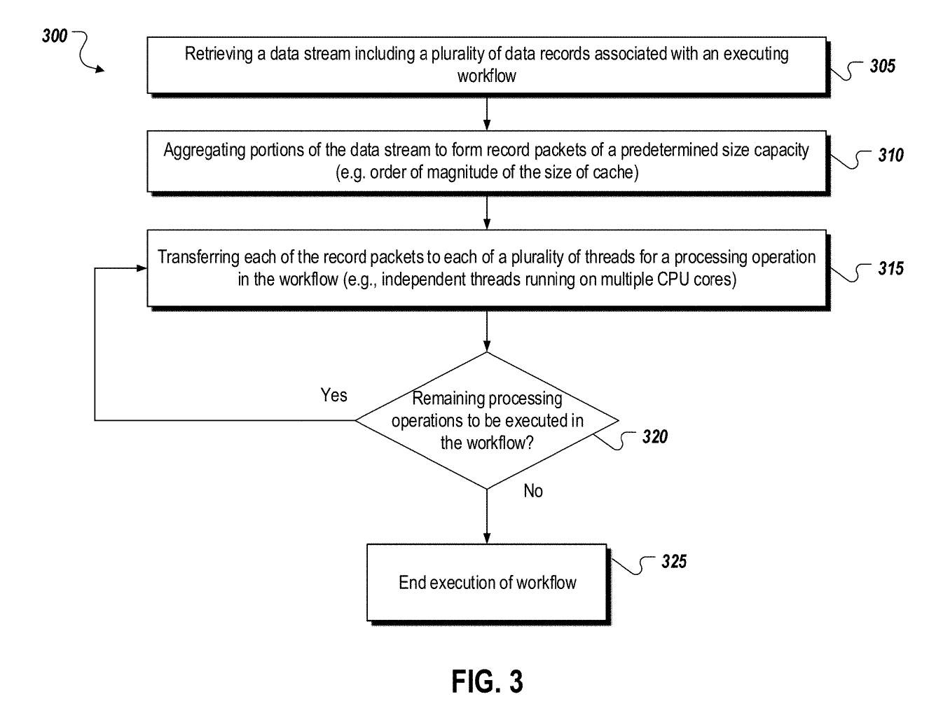

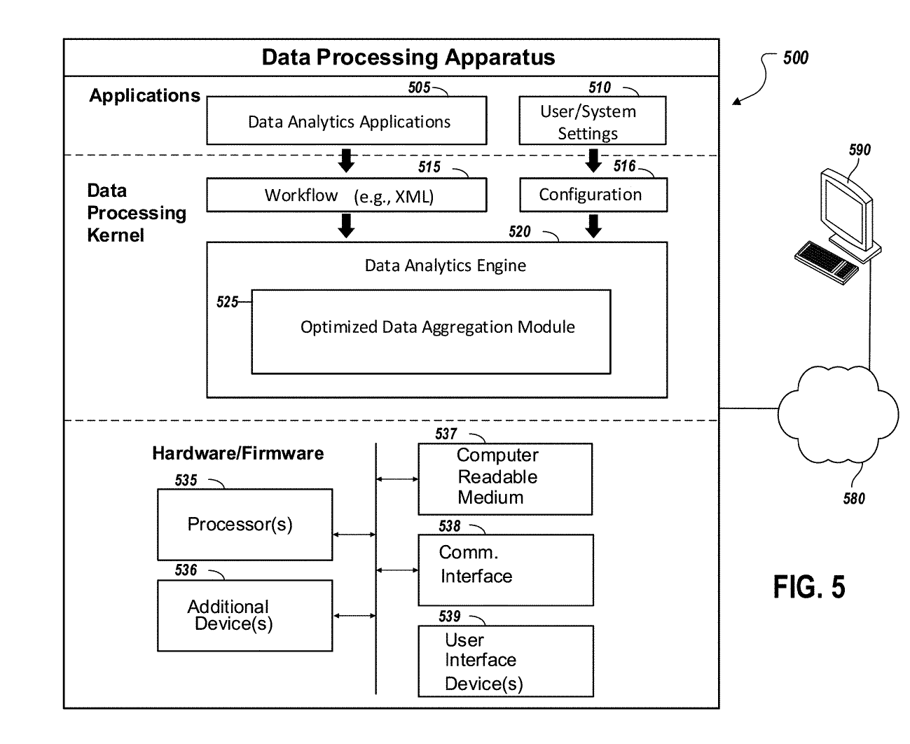

The data analytics system 140 is a computer-based system that can be utilized for processing and analyzing the large amount of data that is collected, gathered, or otherwise accessed from the multiple data sources, via Internet 150 for instance. Data analytics system 140 can implement scalable software tools and hardware resources employed in accessing, preparing, blending, and analyzing data from a wide variety of data source. For instance, data analytics system 140 supports the execution of data intensive processes and workflows. The data analytics system 140 can be a computing device used to implement data analytics functions including the data aggregation techniques described. The data aggregation techniques described can be implemented by a module, which is a portion of a larger data analytics software engine operating within the data analytics system 140. The module, namely an optimized data aggregation module (shown in FIG. 5), is the portion of the software engine (and the associated hardware) that implements the data aggregation techniques in some embodiments. The data aggregation module is designed to operate as an integrated component, functioning with other aspects of the system, such as the data analytics applications 145. Accordingly, data analytics applications 145 can utilize the data aggregation module to perform specific tasks, such as generating record packets that are necessary to carry out its operation. The data analytics system 140 can comprise a hardware architecture using multiple processor cores on the same CPU die, for example, as discussed in detail in reference to FIG. 3. In some instances, data analytics system 140 further employs dedicated computer devices (e.g., servers), shown as data analytics server 120, to support the large-scale data and part of the complex analytics implemented by the system.

The data analytics server 120 can provide a server-based platform for some analytic functions of the system. For example, more time-consuming data processing can be offloaded to the data analytics server 120 that may have greater processing and memory capabilities than other computer resources available on internal network 110, such as a desktop computer 130c. Moreover, the data analytics server 120 can support centralized access to information, thereby providing a network-based platform to support sharing and collaboration capabilities among user accessing data analytics system 140. For example, the data analytics server 120 can be utilized to create, publish, and share applications and application program interfaces (APIs), and deploy analytics across computers in a distributed networking environment, such as internal network 110. The data analytics server 120 can also be employed to perform certain data analytics tasks, such as automating and scheduling the execution data analytic workflows and jobs using data from multiple data sources. Also, the data analytics server 120 can implement analytic governance capabilities enabling administration, management and control functions. In some instances, the data analytics server 120 is configured to execute a scheduler and service layer, supporting various parallel processing capabilities, such as multi-threading of workflows, and thereby allowing multiple data-intensive processes to run simultaneously. In some cases, the data analytics server 120 is implemented as a single computer device. In other implementations, the capabilities of the data analytics server 120 are deployed across a plurality of servers, so as to scale the platform for increased processing performance, for instance.

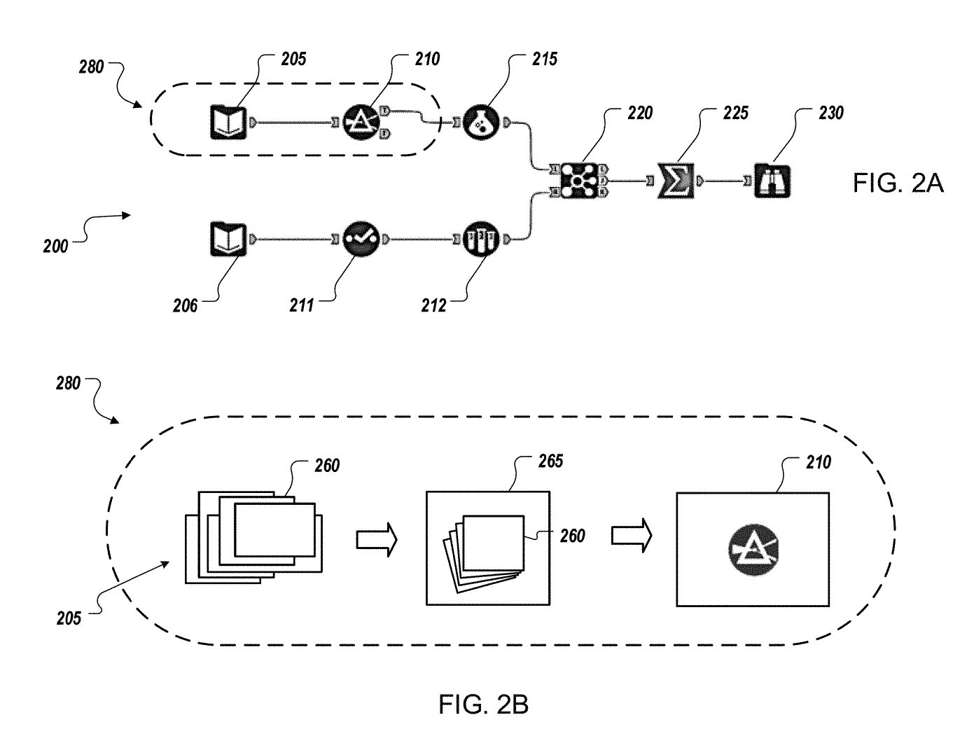

The data analytics system 140 can be configured to support one or more software applications, illustrated in FIG. 2 as data analytics applications 145. The data analytics applications 145 implement software tools that enable capabilities of the data analytics platform. In some cases, the data analytics applications 145 provides software that supports networked, or cloud-based, access to data analytic tools and macros to multiple end users, such as clients 130. As an example, the data analytics applications 145 allows users to share, browse and consume analytics. Analytic data, macros and workflows can be packaged and executed as a smaller scale and customizable analytic application (i.e., app), for example, that can be accessed by other users of the data analytics system 140. In some cases, access to published analytic apps can be managed by the data analytics system 140, namely granting or revoking access, and thereby providing access control and security capabilities. The data analytics applications 145 can perform functions associated with analytic apps such as creating, deploying, publishing, iterating, updating and the like.

Additionally, the data analytics applications 145 can support functions performed at various stages involved in data analytics, such as the ability to access, prepare, blend, analyze, and output analytic results. In some cases, the data analytics applications 145 can access the various data sources, retrieving raw data, for example in a stream of data. Data streams collected by the data analytics applications 145 can include multiple data records of raw data, where the raw data is in differing formats and structures. After receiving at least one data stream, the data analytics applications 145 perform operations to prepare large amounts of data to create data records to be used as input into data analytic operations such as workflows. Moreover, analytic functions involved in statistic, qualitative, or quantitative processing of data records, such as predictive analytics (e.g., predictive modelling, clustering, data investigation) can be implemented by data analytics applications 145. The data analytics applications 145 can also support a software tool to design and execute repeatable data analytics workflows, via a visual graphical user interface (GUI). As an example, a GUI associated with the data analytics applications 145 offers a drag-and-drop workflow environment for data blending, data processing, and advanced data analytics. The techniques described, as implemented within the data analytics system 140, provide a solution that aggregates data retrieved in a data stream into a group, or packet, of multiple data records that enables parallel processing and increases the overall speed of the data analytics applications 145 (e.g., minimizing the synchronization effort by increasing the size of data chunks that are processed).

FIG. 2A shows an example of a data analytics workflow 200 employing the data aggregation techniques for optimized caching and efficient processing. In some cases, the data analytics workflow 200 is created using the visual workflow environment supported by a GUI of the data analytics system 140 (shown in FIG. 1). The visual workflow environment enables a set of drag and drop tools that may eliminate the need for coding and complex formulas that can be involved in some existing workflow creating techniques. In some cases, the workflow 200 can be created as a document expressed in terms of constraints on the structure and content of documents of that type, such as an extensible markup language (XML) document. The data analytics workflow 200 can be executed by a computer device of the data analytics system 140. In some implementations, the data analytics workflow 200 can be deployed to another computer device that may be communicatively connected, via a network, to the data analytics system 140 for execution thereon.

The data analytics workflow 200 can include a series of tools that perform specific processing operations or data analytics function. As a general example, a workflow can include tools implementing various data analytics functions including, but not limited to: input/output; preparation; join; predictive; spatial; investigation; and parse and transform operations. Implementing a workflow 200 can involve defining, executing, and automating a data analytics process, where a data is passed to each tool in the workflow, and each tool respectively performs the associated processing operation on the received data. According to the data aggregation techniques, a data record including an aggregated group of individual data records, can be passed through the tools of workflow 200, which can allow for the individual processing operations to operate more efficiently on the data. The described data aggregation techniques can increase the speed of developing and running workflows, even with processing large amounts of data. The workflow 200 can define, or otherwise structure, a repeatable series of operations, specifying an operational sequence of the specified tools. In some cases, the tools included in a workflow are performed in a linear order. In other cases, more tools can execute in parallel, enabling both the lower and upper portions of workflow 200, for example, to execute simultaneously.

As illustrated, the workflow 200 can include input/output tools, illustrated as input tools 205, 206 and browse tool 230, which function to access data records from particular locations, such as on a local desktop, in a relational database, in the cloud, or third-party systems, and then deliver that data, as output, to a wide variety of formats and sources. Input tools 205, 206 are shown as the initiating operations performed at the start of workflow 200. As an example, input tools 205, 206 can be used to bring data into the module from a selected file or connecting to a database (optionally, using a query) and subsequently provide the data records as input into the remaining tools of the workflow 200. Browse tool 230, located at the end of the workflow 200, can receive the output resulting from execution of each of the upstream tools that are passed by the data records entering the workflow 200. In an example, the browse tool 230 can add one or more points in the data stream to review and verify the data, such as at the end of the data analytics workflow 200 in order to verify results from the executed tools, or processing operations.

In continuing with the example, the workflow 200 can include preparations tools, shown as filter tool 210, select tool 211, formula tool 215, and sample tool 212, that can get the input data records ready for analysis or downstream processes. For example, the filter tool 210 can query records based on an expression to split data into two streams, True (i.e., records that satisfy the expression) and False (i.e., those that do not). Moreover, select tool 211 can be used to select, deselect, reorder and rename fields, change field type or size, and assign a description. The data formula tool 215 is usable to create or update fields using one or more expressions to perform a broad variety of calculations and/or operations. The sample tool 212 can operate to limit the stream of data records to a number, percentage, or random set of records.

The workflow 200 can also include join tools, shown as join tool 220, which can be used for blending multiple data sources through a number of tools. In some instances, join tools can process data from the various sources regardless of the data structure and formats. The join tool 220 can perform combining two data streams based on common fields (or record position). In the joined output, that is passed downstream in the workflow 200, each row will contain the data from both inputs. The workflow 200 is also shown to include parse and transform tool, such as summarize tool 225, which are tools generally used to restructure and re-shape data in order for the data to be analyzed by changing the data to the format they need for further analysis. The summarize tool 225 can perform summarization of data by grouping, summing, counting, spatial processing, string concatenation. The output from the summarize tool 225 contains only the results of the calculation(s), in some instances.

In some cases, execution of workflow 200 will cause the upper input 205 to be read, with records moving one at a time through the filter tool 210 and formula tool 215 until all records are processed and have reached the join tool 220. Thereafter, the lower input 206 will pass records one at a time through the select tool 211 and sample tool 212, and the records are subsequently passed to the same join tool. Some individual tools of the workflow can possess the capability to implement their own parallel operation, such as initiating a read of a block of data while processing the last block of data or breaking computer-intensive operations, such as a sort, into multiple parts.

FIG. 2B shows an example of a portion 280 of the data analytics workflow 200 including a data record as grouped using the data aggregation techniques described herein. As illustrated in FIG. 2B, a data stream can be retrieved including multiple data records 260 in association with executing input tool 205 to bring data into the upper portion of the workflow from a selected file, for example. Subsequently, the data records 260 comprising the data stream can be provided to the data analytics tools along the path, or operation sequence, defined by the upper portion of the workflow. According to the embodiments, the data analytics system 140 can provide a data aggregation technique that can accomplish parallel processing of small portions of the data stream, by grouping a number of the data records 260 from the data stream into a record packet 265. Subsequently, each record packet 265 is passed through the workflow, and processed in a linear order through the multiple tools in the workflow until a tool requires multiple packets, or there are no more tools along the path the record packet 265 is traversing. In an implementation, the data stream is an order of magnitude larger than a record packet 265, and a record packet 265 is an order of magnitude larger than a data record 260. Thus, a number of multiple data records 265, that is a small portion of the sum of data records contained in the entire steam, can be aggregated into a single record packet 265. As an example, a record packet 265 can be generated to have a format including a total length of the packet measured in bytes of multiple aggregated data records 260 (e.g., one data record after another). A data record 260 can have a format including the total length of the record in bytes, and multiple fields. However, in some instances, an individual data record 260 can have a size that is comparatively larger than a predetermined capacity for a record packet 265. Accordingly, an implementation involves utilizing a mechanism to handle this scenario and adjust for packetizing substantially large records. Thus, the data aggregation techniques described can be employed in instances where data records 260 may exceed the designed maximum size for the record packets 265.

FIG. 2B shows a record packet 265 being passed to a next successive processing operation in the data analytics workflow 200, namely filter tool 210. In some cases, data records are aggregated into multiple record packets 265 of a predetermined size capacity. Although data aggregation is generally described as being performed in parallel as a tool reads a data steam from a data source, in some instances, the data aggregation can occur after input data is received in its entirety. As an example, a sort tool can collect each of the record packets for its input stream, and then perform the sorting function, which can involve both a de-aggregation of the record packets as received, and a re-aggregation of data into different packets as a result of the sort function. As another example, a formula tool (shown in FIG. 2A) can generate more than one record packet as output for each record packet that it receives as input. (e.g., adding multiple fields to a packet can increase its size, thereby requiring additional packets upon exceeding capacity).

In one embodiment, the maximum size of a record packet 265 is constrained by, or otherwise tied to, the hardware of a computer system used to implement the data analytics system 140 (shown in FIG. 1). Other implementations can involve determining a size of record packets 265 that is dependent upon system performance characteristics, such as the load of a server. In an implementation, an optimally-sized capacity for record packets 265 can be predetermined (at startup or compilation time) based on a factorable relationship to the size of the cache memory used in the associated system architecture. In some cases, packets are designed to have a direct relationship (1-to-1 relationship) to cache memory, having a capacity that is a 0th order of magnitude (i.e., 10°) to the size of the cache. For example, record packets 265 are configured such that each packet is less than or equal to the size (e.g., storage capacity) of the largest cache on the target CPU. Restated, data records 260 can be aggregated into cache-sized packets. As an example, utilizing a computer system having a 64 MB cache to implement the data analytics applications 145 yields record packets 265 having a predetermined size capacity of 64 MB. By creating a record packet that is less than or equal to the size of a cache of the data analytics system 140, the record packet can be kept in the cache and accessed faster by tools than if it was stored in random access memory (RAM) or a memory disk. Hence, creating a record packet that is less than or equal to the size of a cache improves data locality.

In other implementations, the predetermined size capacity for the record packets 265 can be other computational variations of, or derived from a mathematical relationship to, the size of the cache memory, resulting in packets having a maximum size that is smaller, or larger, than that of the cache. For instance, the capacity of a record packet 265 can be 1/10, or an −1 order of magnitude (i.e., 10⁻¹), of the size of the cache memory. It should be appreciated that optimizing the capacity of the record packets 265 used in the data aggregation techniques described involves a tradeoff between an increased synchronization effort between threads (associated with utilizing smaller sized packets), and potential decreased cache performance or increased granularity/latency in processing per packet (associated with utilizing larger sized packets). In an example, the record packets 265 employed by the data aggregation techniques described are optimally designed having a size capacity of 4 MB. According to the described techniques, the size capacity of a record packet 265 can be any factor ranging from −1 to 1. In other implementations, any algorithm, calculation, or mathematical relationship can be applied for determining the predetermined size capacity of record packets 265 based on the size of a cache memory, as deemed necessary or appropriate.

In some instances, while the size capacity for record packets 265 is fixed, the number of data records that are aggregated to form each record packet 265 length is a variable and dynamically adjusted by the system as necessary or suitable. In accordance with the techniques described herein, record packets 265 are formatted using variable sizes, or lengths, to allow for optimally including as many records as possible into each packet having a predetermined maximum capacity. For example, a first record packet 265 can be generated to hold a substantially large amount of data, including a number of data records 260 to form the packet at a size of 2 MB. Thereafter, a second record packet 265 can be generated and passed to a tool as soon as it is deemed ready. Continuing with the example, the second record packet 265 can include a comparatively smaller number of aggregated records than the first packet, reaching a size of 1 KB, but potentially decreasing the time latency associated with preparing and packetizing data prior to being processed by the workflow. Accordingly, in some instances, multiple record packets 265 traverse the system having varied sizes that are limited by the predetermined capacity, and further not exceeding the size of the cache memory. In an implementation, optimizing a variable size for a packet is performed for each packet that is generated on a per-packet basis. Other implementations can determine optimal sizes for any group or number of packets based on various tunable parameters to further optimize performance including, but not limited to: the type of tools used, minimum latency, maximum amount of data, and the like. Thus, aggregating can further include determining an optimal number of data records 260 to be placed into a record packet 265 in accordance with the packet's determined variable size.

According to some implementations, large amounts of data records 260 can be processed, analyzed, and passed through the various tools and applications of the data analytics system 140 as record packets 265 formed using the aggregation techniques described, thereby increasing data processing speed and efficiency. For example, filter tool 210 can perform processing of a plurality of data records 260 that have been aggregated into the received record packet 265, as opposed to processing each record of a plurality of records 260 individually. Thus, the speed of executing the flow (and ultimately the system) is increased according to the techniques described by enabling parallel processing of multiple aggregated records, without necessitating a software redesign of the respective tools. Additionally, aggregating records into packets can amortize the synchronization overhead. For instance, processing individual records can cause large synchronization costs (e.g., synchronizing record-by-record). In contrast, by aggregating a plurality of records into a packet, the synchronization costs associated with each of the multiple records is reduced to synchronizing a single packet (e.g., synchronization packet-by-packet).

Moreover, in some instances, each record packet 265 is scheduled for processing in a separate thread as available, thus optimizing data processing performance for parallel processing computer systems. As an example, for a data analytics system utilizing multiple threads running independently on multiple CPU cores, each record packet 265 of a plurality of data packets can be distributed for processing by a respective thread on its corresponding core. Multi-threading refers to two or more tasks executing concurrently within a single program. A thread is an independent path of execution within a program. Multiple threads can run concurrently within a program, such as a data processing operation using multiple threads in parallel for executing the various tasks therein. For instance, a data analytics program can initialize a thread, which creates additional threads as needed. Data aggregation can be performed by tool code running on each of the threads associated with the program, with each thread operating on its respective core. The data aggregation techniques described can thus leverage various parallel processing aspects of computer architecture (e.g., multi-threading) to optimize processor utilization, by effectuating data processing across a larger set of CPU cores.

Further, in some embodiments the records associated with two or more record packets are re-aggregated during processing of the workflow 200. In such an embodiment, the data analytics system 140 may have a pre-specified or dynamically-determined minimum capacity indicating a minimum number of records that should be contained within a record packet. If, during workflow processing, a record packet is produced that has fewer data records than the specified minimum, the data analytics system 140 may re-aggregate the data records by placing the records from the below-minimum record packet into one or more other packets, so long as the resulting data records do not exceed the predetermined maximum capacity. If two such record packets have fewer than the minimum number of records, the data analytics system 140 may combine the packets into an additional record packet. Such a re-aggregation may occur, for example, in response to the sort tool re-aggregating data into different packets as a result of the sort function.

FIG. 3 is a flow chart of an example process 300 of implementing data aggregation for optimized caching and efficient processing. The process 300 may be implemented by the data analytics system components described relative to FIG. 1, or by other configurations of components.

At 305, a data stream including a plurality of data records is retrieved for data processing functions. In some data processing environments, such as data analytics platforms, retrieving a data stream can involve gathering large volumes of data represented as multiple records from multiple data sources to be input into a data processing module. In some cases, the data stream, and similarly the data records comprising the stream, are associated with a data analytics workflow executing on a computer device. Additionally, in some instances the data analytics workflow includes one or more data processing operations that can be used to perform a particular data analytics function, such as the tools described in referring to FIG. 2A. Executing a data analytics workflow can further involve executing one or more processing operations according to an operational sequence defined in the workflow.

At 310, portions of the data stream, where each portion corresponds to a group of data records, are aggregated to form a plurality of record packets of a predetermined size capacity. According to the described techniques, each record packet is capable of including a different number of data records, allowing for the packets to be generated having variable sizes, or lengths. Thus, while the size capacity for record packets in the system is fixed (i.e., each record packet has the same maximum length), the number of data records that can be appropriately aggregated to form each packet length can be a variable that is dynamically adjusted by the system as necessary or suitable. In some cases, the number of data records to be aggregated to form a record packet is based on an optimized and variable size determined for each of the respective packets. Details for optimizing record packets using variable sizes is discussed in reference to FIG. 2B. According to the techniques described, the predetermined size capacity is a tunable parameter that is determined, or otherwise calculated, based on a relationship to the hardware architecture. In some cases, the predetermined size capacity for a record packet is a computational variation of the size (e.g., storage capacity) of a cache associated with the processing apparatus running the workflow. In other instances, the size capacity of a record packet can be a computational variation of the largest cache on the target CPU. According to some implementations, the system is configured to dynamically determine the size capacity for record packets at startup by retrieving the size of the cache from the operating system (OS) or the IC chip of the CPU (e.g., CPU ID instruction). In other instances, the predetermined size capacity is a parameter designed for the system at compilation time. Further details for optimally tuning the predetermined size capacity for records packets are discussed in reference to FIG. 2B.

At 315, each of the plurality of record packets are transferred to respective ones of a plurality of threads for executing the one or more processing operations. In some cases, a data processing apparatus implements various parallel processing technologies including having a plurality of processors, for example multiple cores implemented on a CPU. Also, the data apparatus can implement a multiple thread design, where each of a plurality of threads can run independently on a respective processor core of the multi-core CPU, for example.

In some cases, execution of the workflow involves passing record packets to each of the tools, or processing operations, of the workflow to be processed in a linear order (e.g., previous tool completes prior to starting execution of the next tool) until the end of the workflow is reached. Accordingly, at 320, a determination is made as to whether there are any remaining processing operations to be executed in the workflow. In the instance that there are additional processing operations that have yet to be run downstream for the currently executing operation (i.e., “Yes”), the record packets are passed, in order, to the next of the remaining tools in the workflow and the process 300 returns to step 315. In some cases, the check 320 and processing a record packet to the next processing operation, and its associated thread, is performed iteratively until the workflow is completed. In the case that the executed processing operation is the last tool in the process, namely the data analytics workflow, execution of the process is ended at 325.

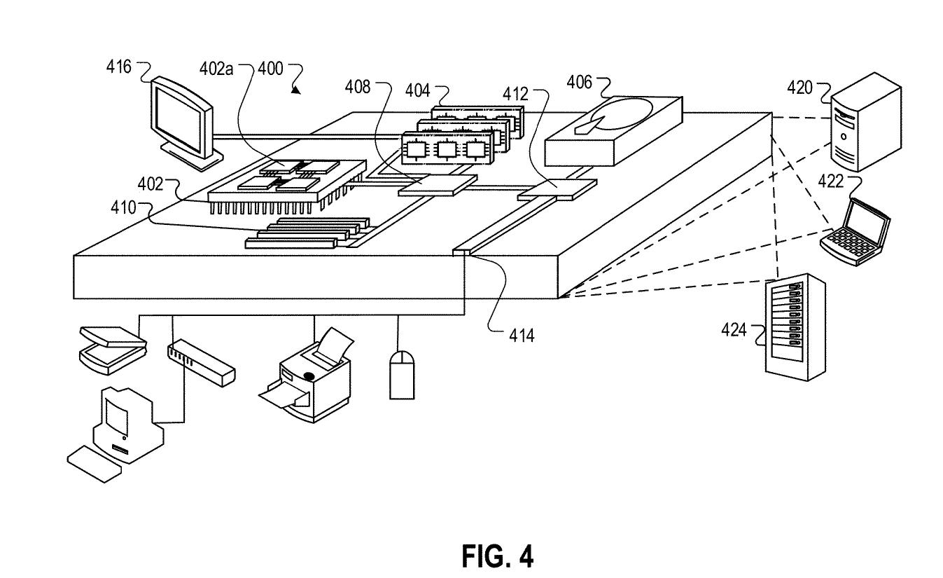

FIG. 4 is a block diagram of computing devices 400 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. In some cases, computing device 450 is intended to represent various forms of mobile devices, such as personal digital assistants, cellular telephones, smartphones, and other similar computing devices. Additionally, computing device 400 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. According to the embodiments, the processor 402 has a design that implements parallel processing technologies. As illustrated, the processor 402 can be a CPU including multiple processor cores 402a on the same microprocessor chip, or die. The processor 402 is shown as having four processing cores 402a. In some cases, the processor 402 can implement 2-32 cores. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk. Memory of the computing device 40 can also include a cache memory that is implemented as a RAM that the microprocessor can access quicker than it can access regular RAM. This cache memory can be integrated directly with a CPU chip and/or placed on a separate chip that has a separate bus interconnect with the CPU.

The storage device 406 provides mass storage for the computing device 400. In one implementation, the storage device 406 may be or contain a non-transitory computer-readable medium, such as a floppy disk device, a hard disk device, an optical disk device, or a tape device, a flash memory or other similar solid state memory device, or an array of devices, including devices in a storage area network or other configurations. The computer program product may also contain instructions that, when executed, perform one or more methods, such as those described above.

The high speed controller 408 manages bandwidth-intensive operations for the computing device 400, while the low speed controller 412 manages lower bandwidth-intensive operations. Such allocation of functions is exemplary. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (shown in FIG. 1). Each of such devices may contain one or more of computing device 400, and an entire system may be made up of multiple computing devices 400 communicating with each other.

FIG. 5 is a schematic diagram of a data processing system including a data processing apparatus 500, which can be programmed as a client or as a server. The data processing apparatus 500 is connected with one or more computers 590 through a network 580. While only one computer is shown in FIG. 5 as the data processing apparatus 500, multiple computers can be used. The data processing apparatus 500 is shown to include a software architecture for the data analytics system 140 implementing various software modules, which can be distributed between an applications layer and a data processing kernel. These can include executable and/or interpretable software programs or libraries, including tools and services of the data analytics applications 505, such as described above. The number of software modules used can vary from one implementation to another. Moreover, the software modules can be distributed on one or more data processing apparatus connected by one or more computer networks or other suitable communication networks. The software architecture includes a layer, described as the data processing kernel, implementing data analytics engine 520. The data processing kernel, as illustrated in FIG. 5, can be implemented to include features that are related to some existing operating systems. For instance, the data processing kernel can perform various functions, such as, scheduling, allocation, and resource management. The data processing kernel can also be configured to use resources of an operating system of the data processing apparatus 500. In some implementations, the data processing kernel has the capability to further aggregate data from record packets previously generated by the optimized data aggregation module 525, so as to reduce wasted capacity and memory usage. For instance, the kernel can determine that the data from multiple nearly empty record packets (e.g., having substantially less data than the capacity) can be appropriately aggregated into a single record packet for optimization. In some cases, the data analytics engine 520 is the software component that runs a workflow developed using the data analytics applications 505.

FIG. 5 shows the data analytics engine 520 as including an optimized data aggregation module 525, which implements the data aggregation aspects of the data analytics system, as disclosed. As an example, the data analytics engine 520, can load a workflow 515 as an XML file, for instance, describing the workflow along with the additional files describing the user and system configuration 516 settings 510. Thereafter, the data analytics engine 520 can coordinate execution of the workflow using the tools described by the workflow. The software architecture shown, particularly the data analytics engine 520 and the optimized data aggregation module 525 can be designed to realize advantages leveraged hardware architectures containing multiple CPU cores, large amounts of memory, multiple thread design, and advanced storage mechanisms (e.g., solid state drives, storage area network).

The data processing apparatus 500 also includes hardware or firmware devices including one or more processors 535, one or more additional devices 536, a computer readable medium 537, a communication interface 538, and one or more user interface devices 539. Each processor 535 is capable of processing instructions for execution within the data processing apparatus 500. In some implementations, the processor 535 is a single or multi-threaded processor. Each processor 535 is capable of processing instructions stored on the computer readable medium 537 or on a storage device such as one of the additional devices 536. The data processing apparatus 500 uses its communication interface 538 to communicate with one or more computers 590, for example, over the network 580. Examples of user interface devices 539 include a display, a camera, a speaker, a microphone, a tactile feedback device, a keyboard, and a mouse. The data processing apparatus 500 can store instructions that implement operations associated with the modules described above, for example, on the computer readable medium 537 or one or more additional devices 536, for example, one or more of a floppy disk device, a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user, as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front end component (e.g., a client device 130 having a graphical user interface or a Web browser through which a user can interact with an implementation of the systems and techniques described here), or any combination of such back end, middleware, or front-end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet 150.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A method performed by a data processing apparatus comprising:
retrieving a data stream comprising a plurality of data records;
aggregating the plurality of data records of the data stream to form a plurality of record packets of a predetermined size capacity, the predetermined size capacity determined responsive to a memory size of a cache memory associated with the data processing apparatus; and
transferring respective ones of the plurality of record packets to respective ones of a plurality of threads associated with one or more processing operations of the data processing apparatus.

2. The method of claim 1, wherein the one or more processing operations are associated with a data analytics workflow executing on the data processing apparatus.

3. The method of claim 2, further comprising:
executing each of the one or more processing operations to perform a corresponding data analytics function on the plurality of record packets in a linear order, wherein the linear order is according to an operational sequence set in the data analytics workflow.

4. The method of claim 3, wherein executing each of the one or more processing operations comprises parallel processing performed by executing each respective thread on a respective processor from among a plurality of processors associated with the data processing apparatus.

5. The method of claim 1, wherein the memory size of the cache memory associated with the data processing apparatus is dynamically determined from an operating system or a central processing unit (CPU) of the processing apparatus.

6. The method of claim 1, wherein the predetermined size capacity is an order of magnitude of the memory size of the cache memory.

7. The method of claim 1, wherein a number of data records aggregated into a record packet is a variable determined for each of the plurality of record packets and does not exceed the predetermined size capacity.

8. The method of claim 1, wherein the aggregating is performed upon retrieving the data stream in its entirety.

9. The method of claim 1, wherein the aggregating is performed in parallel with retrieving the data steam.

10. The method of claim 1, further comprising:
re-aggregating data records associated with two or more record packets of the plurality of record packets into an additional record packet, upon determining that the two or more record packets have a number of data records less than a predetermined minimum capacity.

11. A data processing apparatus comprising:
a non-transitory memory storing executable computer program code; and
a plurality of computer processors having a cache memory and communicatively coupled to the memory, the computer processors executing the computer program code to perform operations comprising:
retrieving a data stream comprising a plurality of data records;
aggregating the plurality of data records of the data stream to form a plurality of record packets of a predetermined size capacity, the predetermined size capacity determined responsive to a memory size of the cache memory; and
transferring respective ones of the plurality of record packets to respective ones of a plurality of threads associated with one or more processing operations of the plurality of processors.

12. The data processing apparatus of claim 11, wherein the one or more processing operations are associated with a data analytics workflow executing on the data processing apparatus.

13. The data processing apparatus of claim 12, wherein the operations further comprise:
executing each of the one or more processing operations to perform a corresponding data analytics function on the plurality of record packets in a linear order, wherein the linear order is according to an operational sequence set in the data analytics workflow.

14. The data processing apparatus of claim 13, wherein executing each of the one or more processing operations comprises parallel processing performed by executing each respective thread on a respective processor from among the plurality of processors.

15. The data processing apparatus of claim 11, wherein the predetermined size capacity is an order of magnitude of the memory size of the cache memory.

16. A non-transitory computer-readable memory storing computer program code executable to perform operations using a plurality of computer processors having a cache memory, the operations comprising:
retrieving a data stream comprising a plurality of data records;
aggregating the plurality of data records of the data stream to form a plurality of record packets of a predetermined size capacity, the predetermined size capacity determined responsive to a memory size of the cache memory; and
transferring respective ones of the plurality of record packets to respective ones of a plurality of threads associated with one or more processing operations of the plurality of processors.

17. The memory of claim 16, wherein the one or more processing operations are associated with a data analytics workflow executing on the plurality of processors.

18. The memory of claim 17, the operations further comprising:
executing each of the one or more processing operations to perform a corresponding data analytics function on the plurality of record packets in a linear order, wherein the linear order is according to an operational sequence set in the data analytics workflow.

19. The memory of claim 18, wherein executing each of the one or more processing operations comprises parallel processing performed by executing each respective thread on a respective processor from among the plurality of processors.

20. The memory of claim 16, wherein the predetermined size capacity is an order of magnitude of the memory size of the cache memory.
